(19) United States
(12) Patent Application Publication
(10) Pub. No.: US 2019/0098009 A1
(43) Pub. Date: Mar. 28, 2019

(54) SYSTEMS AND METHODS FOR AUTHENTICATION USING AUTHENTICATION MANAGEMENT SERVER AND DEVICE APPLICATION

(71) Applicants: Michael Dong Lee, Singapore (SG); Jenny Jee-Young Park, Singapore (SG)

(72) Inventors: Michael Dong Lee, Singapore (SG); Jenny Jee-Young Park, Singapore (SG)

(21) Appl. No.: 16/125,706

(22) Filed: Sep. 9, 2018

Related U.S. Application Data
(60) Provisional application No. 62/564,281, filed on Sep. 28, 2017.

(51) Int. Cl. H04L 29/06; G06F 21/32; G06F 21/45; H04L 9/08; H04L 29/08

(52) U.S. Cl. CPC H04L 63/0892; H04L 63/083; G06F 21/32; G06F 21/45; H04L 9/0863; G06F 2221/2137; H04L 63/108; H04L 67/26; H04L 67/32; G06F 2221/2117; H04L 63/102

(57) ABSTRACT

Methods and systems are provided for authenticating a user with a service provider by implementing an independent authentication management server along with its accompanying cross-platform device application installed on a user's device which provides, among other things, a secure and seamless exchange of sensitive data between a user and the service provider. An authentication management server system may further create, store, and manage a user's sensitive data and securely manage exchange of various requests and corresponding approvals between a user and the service provider. A method for authentication of a user to a service provider, the method being performed by an authentication management server system, include receiving a request from a service provider for a user's password, other personal information, an approval to take specific actions, or an approval to register a new device; transmitting the request to one or more registered devices of the user; and transmitting the user's corresponding approval to the service provider upon the user's approval. The systems and methods of the present disclosure supplements or eliminates the need for a typical password-based authentication process and multi-factor authentication methods.

### FIELD OF INVENTION

The present disclosure relates to systems and methods for authentication using an authentication management server and its accompanying device application installed on a user's device. More particularly, the present disclosure relates to systems and methods of exhanging sensitive data between a service provider and a user.

### BACKGROUND

Traditional password-based systems and methods for authentication of a user have many problems. Due to these problems a user's password became less reliable and some service providers, especially financial institution's, often require additional layers of authentication such as “one time password” which is sent to a user's device or email, “token” that generates random password which must be copied and re-entered, etc. These multi-factor authentication methods to remedy problems and enhance security are often burdensome and inconvinent.

Other types of development have been unsuceesful. For example, random password generator has not been effective because it generates ‘random’ password which most users cannot possibly remember. Recently, biometric data is often used as a password to unlock various devices, but using a user's biometric data as an authentication credential for other services is not without some drawbacks. Additionally, an idea that a service provider or a third party may possess a user's unique biometric data as a password may not get necessary public support because of security and privacy concern and the fact that biometric data cannot be changed or reset if a service provider's system, a third party's system or a data itself is compromised or otherwise changing the password becomes necessary.

When it comes to authentication, convenience and security always have had negative correlation forcing a service provider and a user to constantly balance the two and compromise one over the other. The above information is provided as background information only to assist with an understanding of the present disclosure. No determination has been made, and no assertion is made, as to whether any of the above might be applicable as prior art with respect to the present disclosure.

### SUMMARY

The present disclosure provides, among other things, novel methods and systems of authenticating a user with a service provider using an authentication management server along with its accompanying cross-platform device application installed on a user's device. The systems and methods of the present disclosure provide significant convenience and increased transaction security for a user and a service provider by supplementing or eliminating the need for a typical password-based authentication process.

According to aspects of the inventions, an authentication management server system may enable a user to securely log into and/or transact with a service provider by providing a secure and seamless exchange of sensitive data between a user and the service provider whether a user is using his own device on a secure network or a public device on an unsecured public network. For a service provider, an authentication management server may relay its various requests for specific actions or information previously stored by the user to the user and securely relay back authenticated approvals and/or corresponding information from the user. For a user, an authentication management server can create, store, manage and/or securely transmit a user's personal information including passwords to a service provider upon the user's express instruction to do so.

As an illustrative example for the above aspect, an authentication management server system may function as a verified and trusted escrow system between a service provider and a user that securely transmits approvals for various requests a service provider requires only upon express consent by an authorized user. An authentication management server may further function as a personal data management system which assists a user to create, store and manage the user's sensitive personal data, including passwords, and transmits necessary information when requested by a service provider on behalf of a user only upon express consent by an authorized user. A user would be able to monitor & review all transactions associated with his ID prior to authorizing such transactions. Further, a user would not have to create, store, remember or enter any password to log-in or execute a transaction. A service provider and a user can securely interact with each other without the need for traditional password-based authentication, two-factor authentication method to log the user in or traditional OTP method to execute a specific transaction.

Aspects of the invention may also provide for a device to device authentication method where a user can register additional devices by installing an approval app under the same user ID on other devices for convenience or as a recovery or authentication device for added security without a password. A traditional method of authenticating and registering additional devices for many cloud-based servers and its mobile device application involves a user ID and a password. A device to device authentication method may use at least one registered device to authorize and register a new device as an alternative or addition to a traditional password authentication.

As an illustrative example for the above aspect, an authentication management server may function as a cloud-based device manager for an approval app, its accompanying device application. When an approval app on the new device attempts to log-in to an authentication management server using an existing ID, an authentication management server may transmit to the new device various options to register the new device. One or more options may include registering the new device using already registered devices where an authentication management server may transmit a request for an approval to add the new device to the user's registered device. Upon approval from one of the registered device by a user, the authentication management server may register the new device and a person who has the authority to unlock the new device may access an approval app.

The present disclosure provides a secure and convenient method, system and platform for exchanging sensitive data necessary to authenticate a user and his transaction by using an authentication management server system with its accompanying device application. The present disclosure further provides a secure and convenient method, system and platform for creating, storing, managing, and transmitting a user's sensitive personal data. The present disclosure further provides a secure and convenient method, system and platform for managing a user's devices. Other aspects, advantages, benefits, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

FIG. 1 illustrates a typical environment in which a user and a service provider interact with each other;

FIG. 2 illustrates an example environment in which an authentication management server is used to manage sensitive data between a service provider and a user;

FIG. 3 illustrates an example environment in which the present disclosure may be used in various circumstances where a user and a service provider may interact with each other in accordance with at leaest one embodiment disclosed herein;

FIG. 4 illustrates an example environment in which an authentication management system is consisted of an authentication management server, system database and a device application in accordance with at leaest one embodiment disclosed herein;

FIG. 5 is a flow diagram showing an examplary routine for installing a device app on a user's device in accordance with at leaest one embodiment disclosed herein;

FIG. 6 is a flow diagram showing an examplary routine for a service provider to obtain a user's ID and authenticating a user in connection with various services an authentication management server may perform in accordance with at leaest one embodiment disclosed herein;

FIG. 7 is a flow diagram showing an examplary routine for transmitting a user's unique password to a service provider in accordance with at leaest one embodiment disclosed herein;

FIG. 8 is a flow diagram showing an examplary routine for transmitting a user's approval to take a specific action to a service provider in accordance with at leaest one embodiment disclosed herein;

FIG. 9 is a flow diagram showing an examplary routine for transmitting a user's other personal information to a service provider in accordance with at leaest one embodiment disclosed herein;

FIG. 10 is a flow diagram showing an examplary routine for enrolling and registering additional device to an authentication management server in accordance with at leaest one embodiment disclosed herein;

FIG. 11 is a screenshot of an exemplary device application user interface for setting up a new ID in accordance with at leaest one embodiment disclosed herein;

FIG. 12 is a screenshot of an exemplary device application user interface for registering a new device in accordance with at leaest one embodiment disclosed herein;

FIG. 13 is a screenshot of an exemplary device application user interface for creating a new user profile in accordance with at leaest one embodiment disclosed herein;

FIG. 14 is a screenshot of an exemplary device application user interface for creating a master password in accordance with at leaest one embodiment disclosed herein;

FIG. 15 is a screenshot of an exemplary device application user interface for granting approval to register a new device in accordance with at leaest one embodiment disclosed herein;

FIG. 16 is a screenshot of an exemplary user interface of a service provider's mobile website or mobile application equipped with an option to sign-up using an authentication management server ID in accordance with at leaest one embodiment disclosed herein;

FIG. 17 is a screenshot of an exemplary user interface of a service provider's mobile website or mobile application equipped with an option to log-in using an authentication management server ID in accordance with at leaest one embodiment disclosed herein;

FIG. 18 is a screenshot of an exemplary device application user interface for granting approval to transmit a password in accordance with at leaest one embodiment disclosed herein;

FIG. 19 is a screenshot of an exemplary device application user interface for viewing the request in detail in accordance with at leaest one embodiment disclosed herein;

FIG. 20 is a screenshot of an exemplary device application user interface for granting approval in accordance with at leaest one embodiment disclosed herein;

FIG. 21 is a screenshot of an exemplary device application user interface for viewing a request for additional information in detail in accordance with at leaest one embodiment disclosed herein;

FIG. 22 is a screenshot of an exemplary device application user interface for viewing a request in detail in accordance with at leaest one embodiment disclosed herein;

FIG. 23 is a screenshot of an exemplary device application user interface for alerting a user to enable “lock” feature of the device the user intend to use in accordance with at leaest one embodiment disclosed herein;

FIG. 24 is a screenshot of an exemplary device application user interface for granting approval for additional information in accordance with at leaest one embodiment disclosed herein;

FIG. 25 is a screenshot of an exemplary device application user interface for granting an approval for a specific action in accordance with at leaest one embodiment disclosed herein;

FIG. 26 is a screenshot of an exemplary user interface of a service provider's website equipped with an option to log-in using an authentication management server ID in accordance with at leaest one embodiment disclosed herein;

FIG. 27 is a screenshot of an exemplary device application user interface for granting approval to transmit a password in accordance with at leaest one embodiment disclosed herein;

FIG. 28 is a screenshot of an exemplary device application user interface for granting approval to transmit a password in accordance with at leaest one embodiment disclosed herein;

FIG. 29 is a screenshot of an exemplary device application user interface for authenticating a user in accordance with at leaest one embodiment disclosed herein;

FIG. 30 is a screenshot of an exemplary device application user interface for granting approval for a specific action in accordance with at leaest one embodiment disclosed herein;

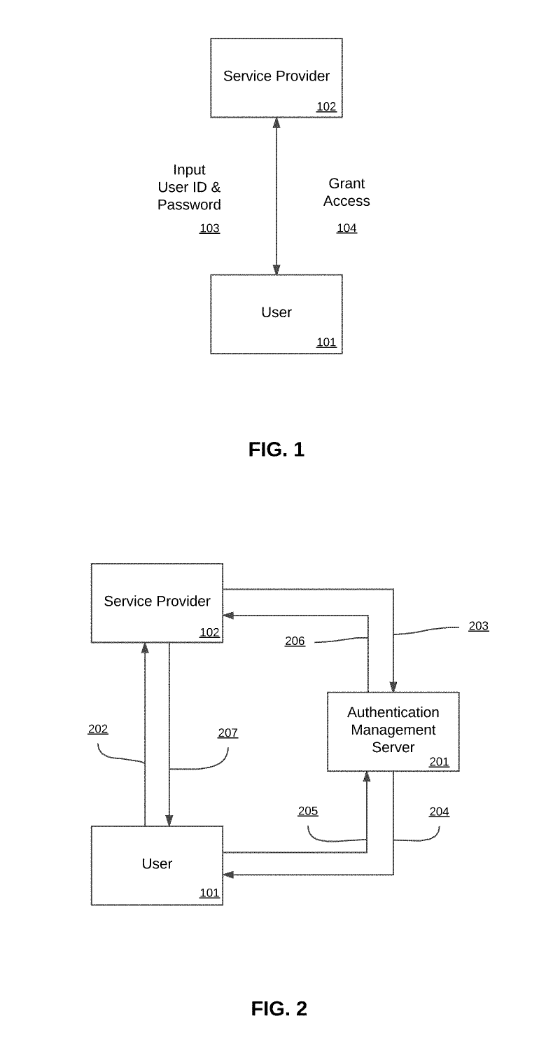

### DETAILED DESCRIPTION

Various embodiments described herein provide for systems and methods which securely and conveniently authenticate a user to a service provider using an authentication management server and its accompanying cross-platform device application software which can be installed on a user's device.

The following description with reference to the accompanying drawings is provided to assist in a comprehensive understanding of various embodiments of the present disclosure as defined by the claims and their equivalent. The terms and words used in the following description and claims are merely used by the inventor to enable a clear and consistent understanding of the present disclosure without needless repetition of all its meaning, kinds, variation, and applications each time a term or word is used. Various specific details and embodiments in this application are used to describe the principles of the present disclosure and to assist in that understanding. They are provided for illustration purposes only and they are not to be construed as exhaustive or as to limit the present disclosure as defined by the claims and their equivalent. Accordingly, those of ordinary skill should be able to recognize that various changes and modifications of the various embodiments described herein can be made without departing from the scope and spirit of the present disclosure. It is to be understood that the singular forms “a,” “an,” and “the” include plural referents unless the context clearly dictates otherwise. In addition, descriptions of well-known functions and constructions may be omitted for clarity and conciseness.

Approve: A term used to describe an action a user takes to authorize a user's computing or mobile device to transmit specific commands to an authentication management server.

Approval App: A term used to describe a unique cross-platform device application software which can be installed on a user's device to communicate with a service provider through its associated authentication management server.

Approval ID: A term used to distinguish a user's ID for the approval app and its authentication management server from other IDs a user used for other service providers.

Authentication Management Server: A term used to describe a server system that communicates on a secured network with a service provider and a user through its device application described as an approval app, installed on a user's device.

Biometric Authentication: A term used to describe a security process of a computing or mobile device that relies on the unique biological characteristics of a user including, fingerprint, facial recognition, voice recognition and/or retina/iris scan to verify the user so the user can unlock his device or, once a device is unlocked, to authorize a device or an application installed on his device to perform specific action if a request is approved.

Device: A term used to describe any computing device, such as a desktop, a laptop computer, a terminal, kiosk and any mobile device such as mobile phone, smart phone or tablet device with a network connectivity including, via internet, intranet, cellular network and/or VPN.

Password: A term used to describe a string of characters such as PIN or authorization code to authenticate a user to a service provider so the user may log-in to the service provider's system, database or network, or authorize the service provider to perform a certain action. A certain action can include, for example, a financial transaction.

Push notification: A term used to describe any message which appears on a user's device display as a result of a service provider pushing or transmitting a content, sometimes using an installed application or an open window of a website, in the form of a banner, alert, pop-up bubble, or dialog box.

Request (for Approval): A term which describes a message a service provider transmits to a user's device display, through an authentication management server, seeking a specific action from a user.

Service Provider: A term used to describe any private or public entity which maintains, as a part of its service, an accessible system, database, or network for a user to use and/or transact within either through an internet based service such as a website, VPN, remote network, a separate software application installed on a user's device, intranet based connection or a specialized remote terminal such as ATM or airline kiosk. The term also includes any private or public entity which a user may physically its place of business such as a bank teller, library, DMV (Department of Motor Vehicle) or dial-in to an automated system or to a live customer service staff such as phone banking and upon authentication of a user's identity, a user can access, use and/or transact within the service provider's database, network, or system.

User: A term used to describe any individual who wants to access a service provider's database, network or system such as an employee, a customer, or a member.

One or more embodiments described herein provide that methods, techniques, and actions performed by a device are performed programmatically, or as a computer-implemented method. Programmatically, as used herein, means through the use of code or computer-executable instructions. These instructions can be stored in one or more memory resources of the computing device. Programmatically performed step may or may not be automatic.

One of more embodiments described herein can be implemented using programmable modules, engines, or components. A programmable module, engine, or component can include a program, a sub-routine, a portion of a program, or a software component or a hardware component capable of performing one or more stated tasks or functions. As used herein, module or component can exist on a hardware component independently of other modules or components. Alternatively, a module or component can be a shared element or process of other modules, programs or machine.

Some embodiments described herein can generally require the use of computing devices, including processing and memory resources. For example, one or more embodiments described herein may be implemented, in whole or in part, on computing devices such as servers, desktop computers, laptop computers, mobile phones, smart phones, tablet devices and network devices. Memory processing and network resources may all be used in connection with the establishment, use, or performance of any embodiment described herein including with the performance of any method or with the implementation of any system.

Furthermore, one or more embodiments described herein may be implemented through the use of instructions that are executable by one or more processors. These instructions may be carried on a computer-readable mediums on which instructions for implementing embodiments described herein can be carried and/or executed. In particular, the numerous machines shown with examples described herein include processor(s) and various forms of memory for holding data and instructions. Examples of computer-readable mediums include permanent memory storage devices, such as hard drives and SSD (Solid State Drive) on personal computers or servers. Other examples of computer storage mediums also include portable storage units, such as CD or DVD, flash memory, SSD, and magnetic memory. Computers, terminals, and network enabled devices are all examples of machines and devices that utilize processor, memory, and instructions stored on computer-readable mediums. Additionally, embodiments may be implemented in the form of computer-programs, or computer usable carrier medium capable of carrying such a program.

Authentication Management Server Description

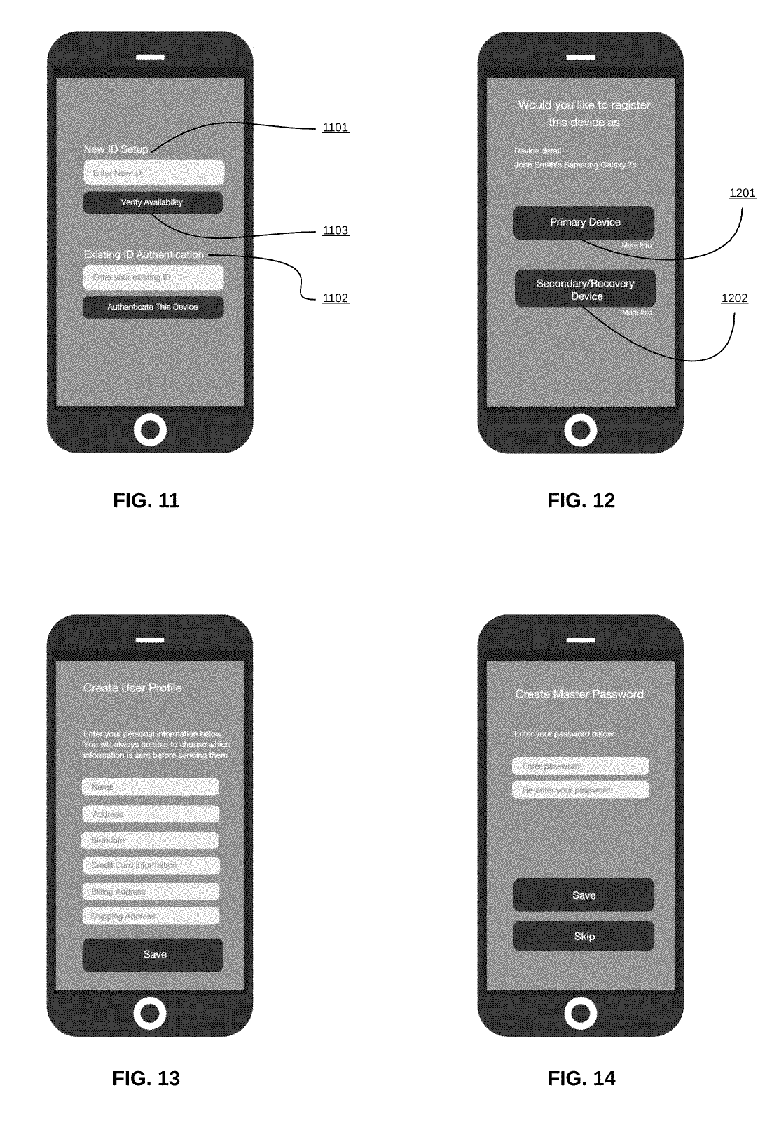

In some exemplary implementations, the following steps illustrate how a user may set up a new account and ID with an authentication management server. A user may start by downloading an approval app, the authentication management server's accompanying device app, from various resources. Such resources can include, for example, a website, Microsoft Store, App Store and Google Play. A user then installs and runs an approval app on the user's device which may guide the user through an account set-up process. A new account set-up process can include, for example, possible two options such as “Set-up new ID” 1101 or “Already have an account” 1102 for a user to choose from (FIG. 11).

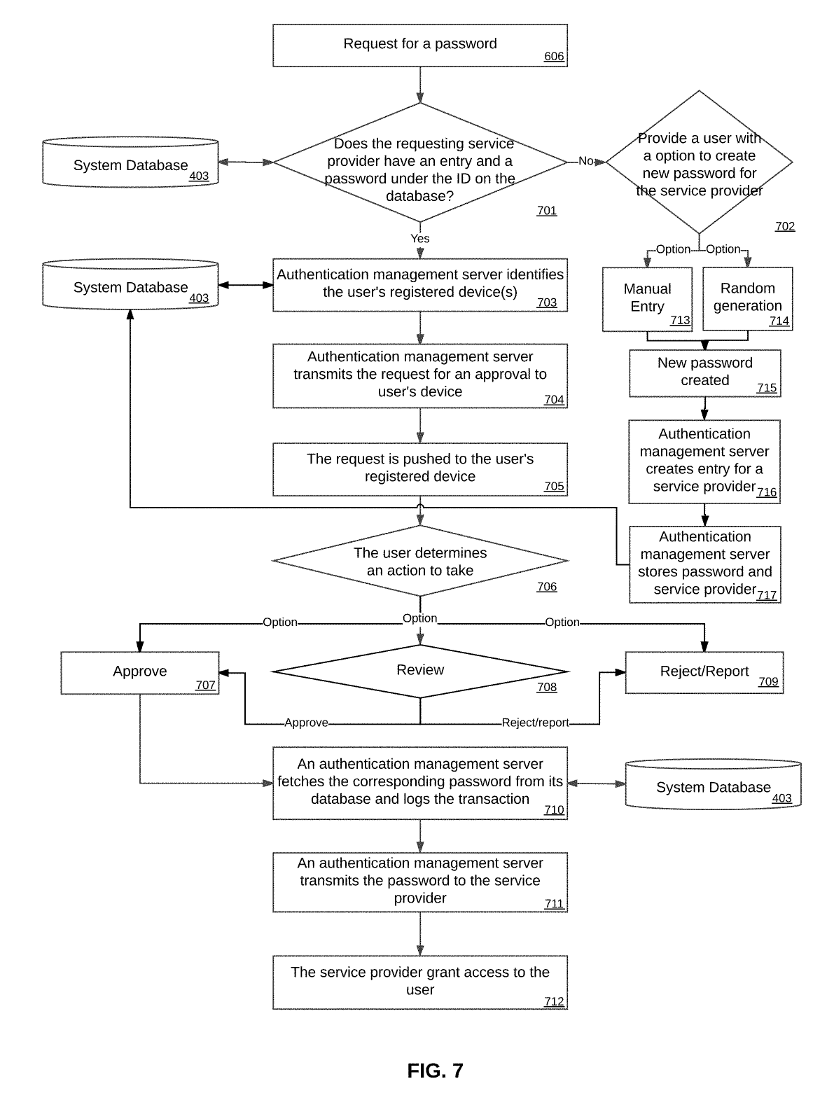

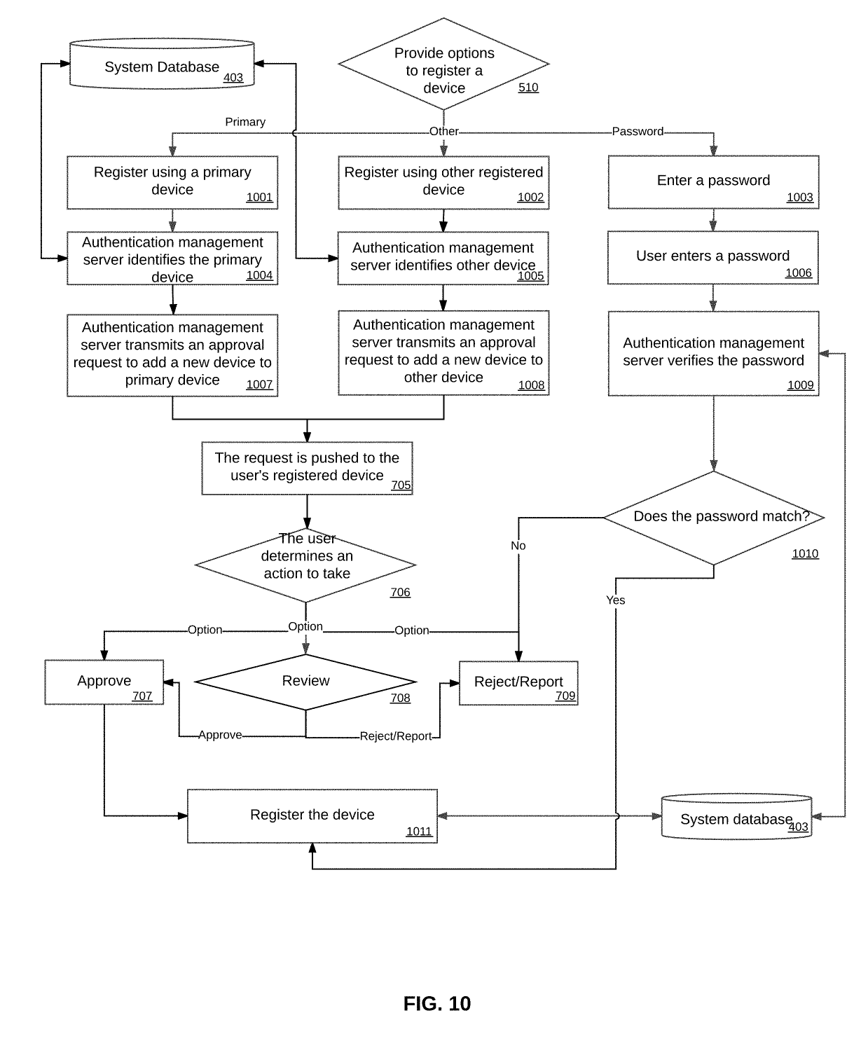

The user may click on “set-up new ID” option 1101 and click on “Verify Availability” 1103 (FIG. 11). Once an approval app confirms that the user's newly entered approval ID is unique and usable, the user may proceed to register his device as “trusted device” with an authentication management server (FIG. 12). An authentication management server then may create a new entry for the new approval ID and links the user's device (FIG. 10). An authentication management server can also create, store, manage, and/or transmit a password to a service provider upon the user's approval (FIG. 7). In another exemplary implementation, an authentication management server can further maintain, manage, and/or transmit a user's profile and other information to a service provider upon the user's approval (FIG. 7).

In another exemplary implementation, the user can further register his device either as a primary device 1201 or an additional device 1202 (FIG. 12). If the user registers his device as one of primary devices, the authentication management server may vest the device with an authority to approve various requests from a service provider along with other administrative privileges such as access to settings, device management, viewing of transaction logs and so on.

In another exemplary implementation, a user may be prompted to create a password for the approval app and its associated authentication management server so a user may set up additional device more conveniently and to access various administrative settings and device management (FIG. 14).

In another exemplary implementation, the following steps illustrate a device to device authentication method where a user can further register additional devices by installing an approval app under the same user ID on other devices for convenience or as a recovery or authentication device for added security without a password (FIG. 10). A traditional method of authenticating and registering additional devices for many cloud-based servers and its mobile device application involves a user ID and a password. A device to device authentication method uses at least one already registered device to authorize and register a new device.

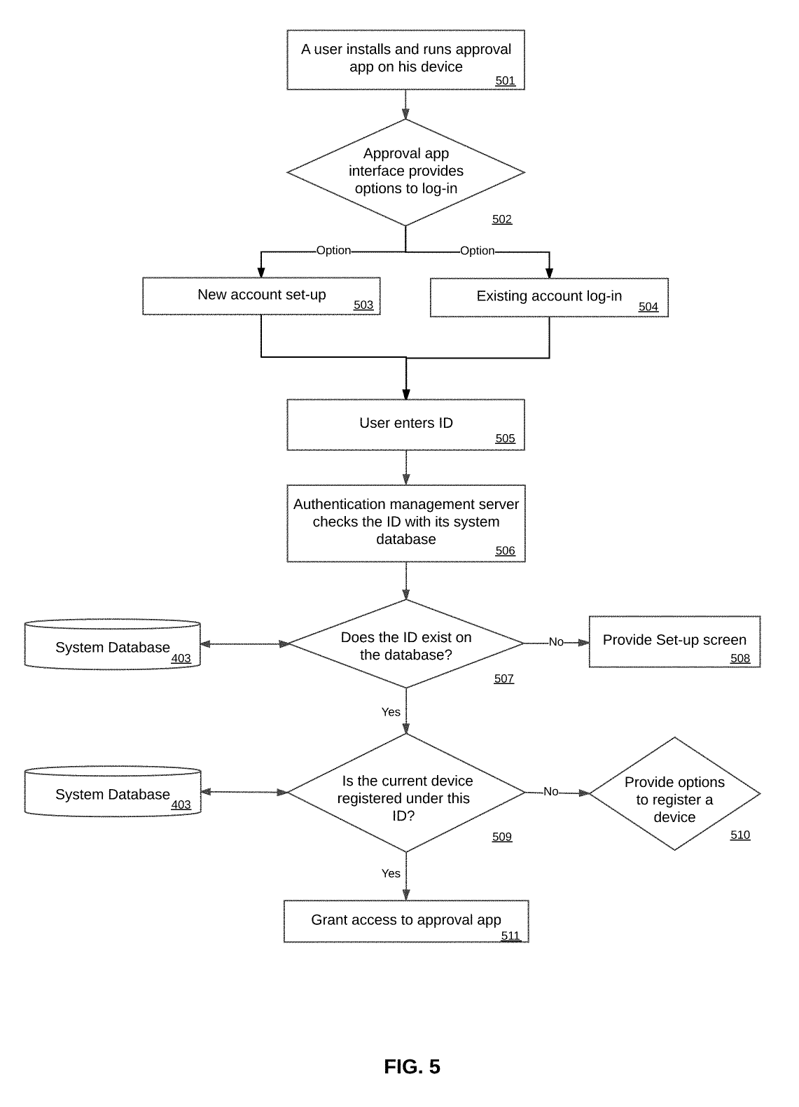

In this exemplary implementation, the following steps illustrate how a user may register additional devices or an additional user using the approval app on his existing device. The user can follow the steps illustrated in FIG. 5 to download, install, and run the approval app on a new device (e.g., an IPad or a tablet PC), which the user intends to register. On the approval app's user interface on the new device, the user can click on “Already have an account” option 1102 and enter his existing approval ID. The approval app, after communicating with the authentication management server, can confirm the existing ID and further display that the current device is not registered as the “trusted device” and provide the user with possible three options to proceed: (FIG. 10) Option 1: Register this device using one of the primary devices 1001. Option 2: Register this device using other registered devices 1002. Option 3: Register this device using the password 1003.

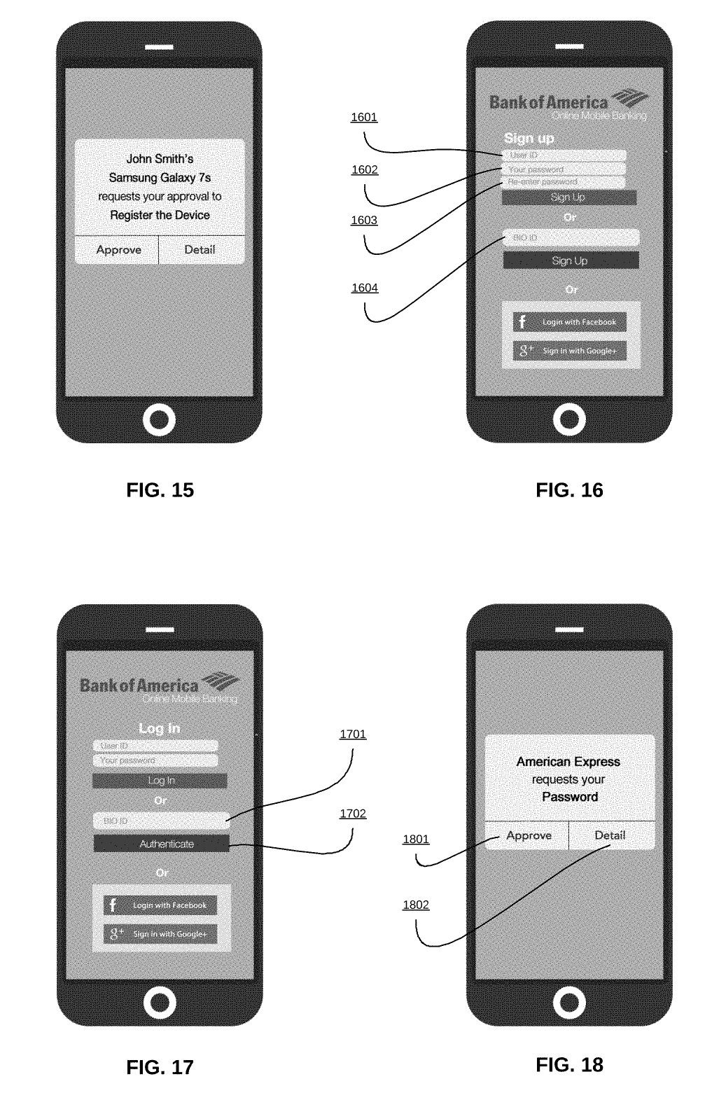

When the user clicks on Option 1 1001, the authentication management server communicates with the user by transmitting a request (to add an additional device) for approval via push notification function of approval app on his already-registered primary device 1007 (FIG. 10) as illustrated in FIG. 15. The request from the service provider can only be transmitted to registered primary devices that the user previously registered. Therefore, the new device, which is not yet registered, will not receive the request but the user's other registered primary devices (e.g., a mobile phone) will receive the request. The user can review and approve the request from the authentication management server on his registered primary devices (e.g., a mobile phone in his pocket) if it is legitimate and the user wishes to proceed 707. When the user approves the request on his device, the authentication management server registers the new device under the user's approval ID 1011. The user can repeat these steps to register other devices.

In another exemplary implementation, the user can use the above procedure to add a new user (e.g., a caretaker, parent or otherwise an individual the user trusts or a company IT administrator) under the same approval ID (FIG. 5 and FIG. 10). In this example, the new user must have the device unlocking authority for the newly added device. The user may grant full or limited privileges within the approval app to the new device.

In some exemplary implementations, the following steps illustrate how a user with an existing approval ID may set up a new account with a service provider (FIG. 7). A service provider can feature an account set-up screen enabled with an approval ID field and an authentication icon button or link, 1604 which can be programmed to send a specific request command to the authentication management server instead of, or in addition to, providing traditional data fields such as the ID, 1601, password 1602, and to reconfirm password 1603 (FIG. 16).

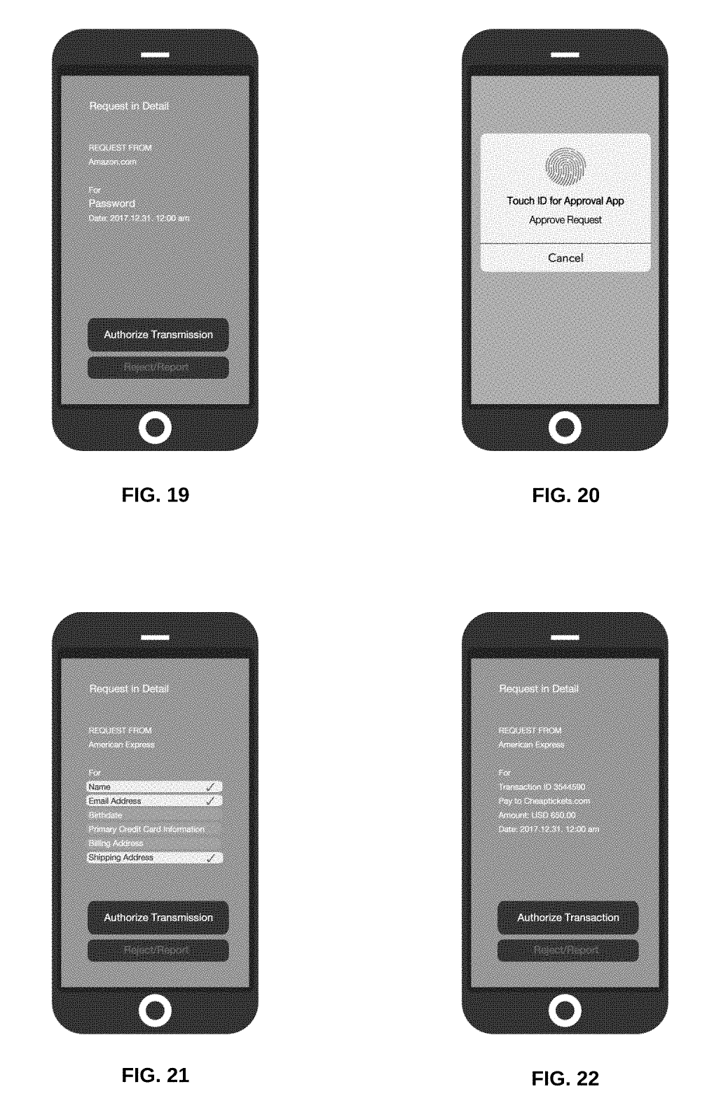

A user may enter his approval ID already created 1101 in the authentication management server through its accompanying approval app on his device (FIG. 11). The service provider then transmits a request for a new password to the authentication management server 606 to finish the set-up process after it confirms that the provided approval ID does not conflict with any accounts already on its file. The authentication management server can communicate with the user via push notification function of the approval app on the registered device by transmitting a request for approval (FIG. 18). A request may include a summary, brief or detailed actions which an authentication management server is to perform if approved by a user through an approval app (FIG. 19).

An approval on a device can be achieved by simply unlocking the device when the request from the service provider is pushed to a device using either any biometric authentication process such as retina or iris scan on Microsoft device, facial recognition or Touch ID on Apple device, similar fingerprint scan on Android device, password or pattern input or any other means a user has set up on a device (FIG. 20). In another exemplary implementation, an approval can also be achieved by first unlocking the device and tapping on the request, message, banner, alert, pop-up bubble or dialog box received via push notification to review its request 1802 and then approve, in whole or in part (FIG. 21), the request using the same or similar method as required to unlock the device for added security as illustrated in FIG. 20.

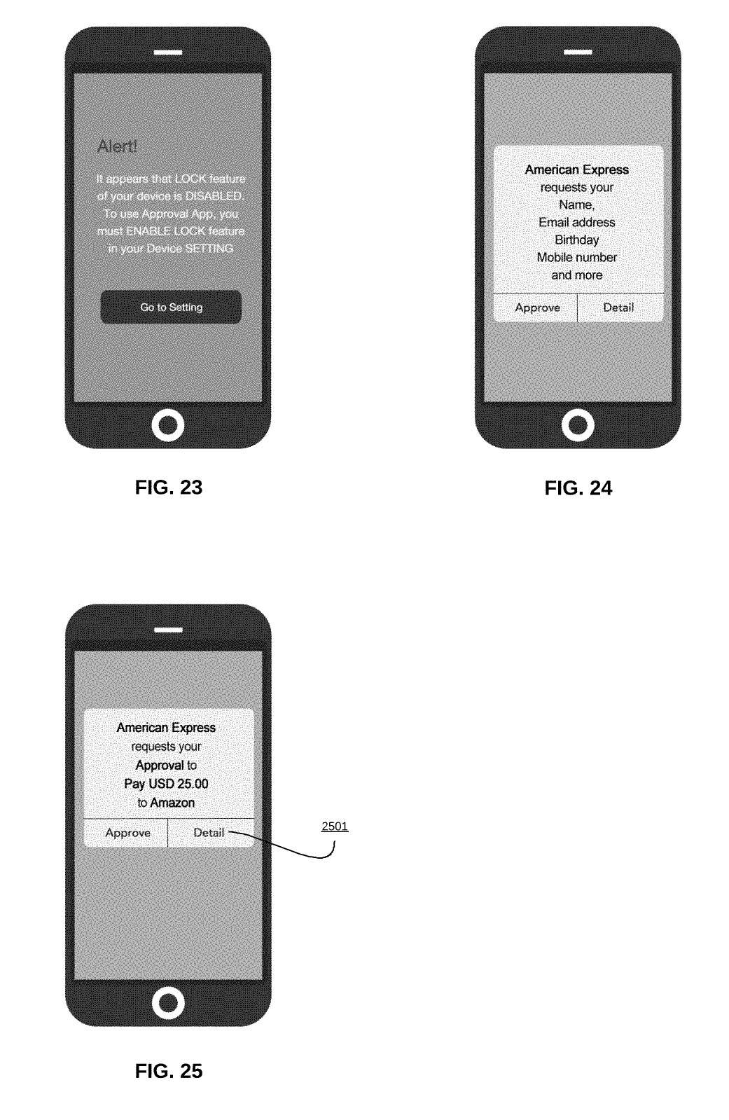

In another exemplary implementation, a user who did not set up any authentication process for unlocking the device may still be required, by an approval app, to set up a device's own biometric authentication process, password or pattern input, or any other means usually associated with unlocking the device before using an approval app for added security (FIG. 23). Biometric data of a user that the device stores internally does not get transmitted to an authentication management server or any other service provider; it does not get stored on an authentication management server or any other service provider.

The user can review the request from a service provider on his device and approve the request if it is legitimate and the user wishes to proceed. When the user approves the request on his device, an authentication management server identifies, creates and indexes the name of the new service provider under the user's ID 716, generates password unique to the service provider either by automated random generation 714 or user's manual entry 713, then transmits newly created, preferably encrypted, password back to the requesting service provider for its record keeping 711. Upon receiving the new password associated with the approval ID, the service provider may create an account and direct the user to rest of the set-up or enrollment process so the user may input additional data manually. A user may repeat the above steps whenever the user wants to open new accounts with various service providers. This exemplary embodiment further illustrates that an authentication management server may allow a user to have almost unlimited number of service provider accounts with all unique different passwords for each account without a user having to create passwords; store them in any other place; remember them; find them; transfer them; or even enter them. An authentication management server may further reduce the risk of losing passwords; misplacing them; or having other people spying or phishing on them.

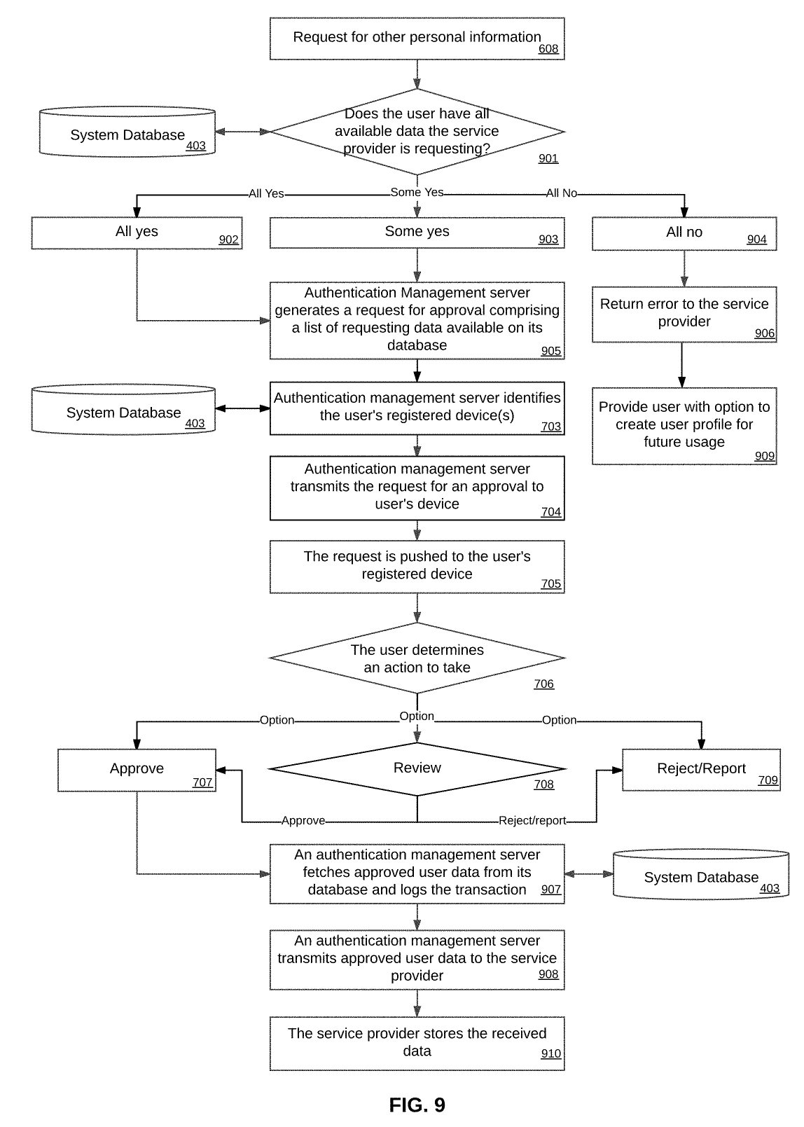

In another exemplary implementation, the service provider can further transmit additional requests for other information generally associated with an account opening process such as name, credit card information, email address and so on to the authentication management server (FIG. 9). The authentication management server then communicates with the user via push notification function of the approval app on his registered device by transmitting a request for approval (FIG. 24). When the user approves the request, the authentication management server transmits approved corresponding information on file back to the service provider 908 for automatic data entry and/or for its record 910. A user may approve the request in whole or in part and reject the rest of the request (FIG. 21) and proceed to either manually enter information on the user interface platform provided by the service provider or decline to enter more information.

In some exemplary implementations, the following steps illustrate how a user with an existing approval ID can log in to a service provider which a user already has an existing account with using a registered device 302, 304, or 305. A user simply enters his approval ID or allows user's device to auto-fill the ID data field 1701 and clicks “Authenticate” link or button 1702 without having to enter a matching password. The user's registered device can be the same device he is using to access a service provider's system such as his mobile device 304. In another example, the user can use one registered device 302 (e.g., his laptop or desk top computer) to access the service provider's system while having his other registered device 304 (e.g., mobile phone) in his pocket.

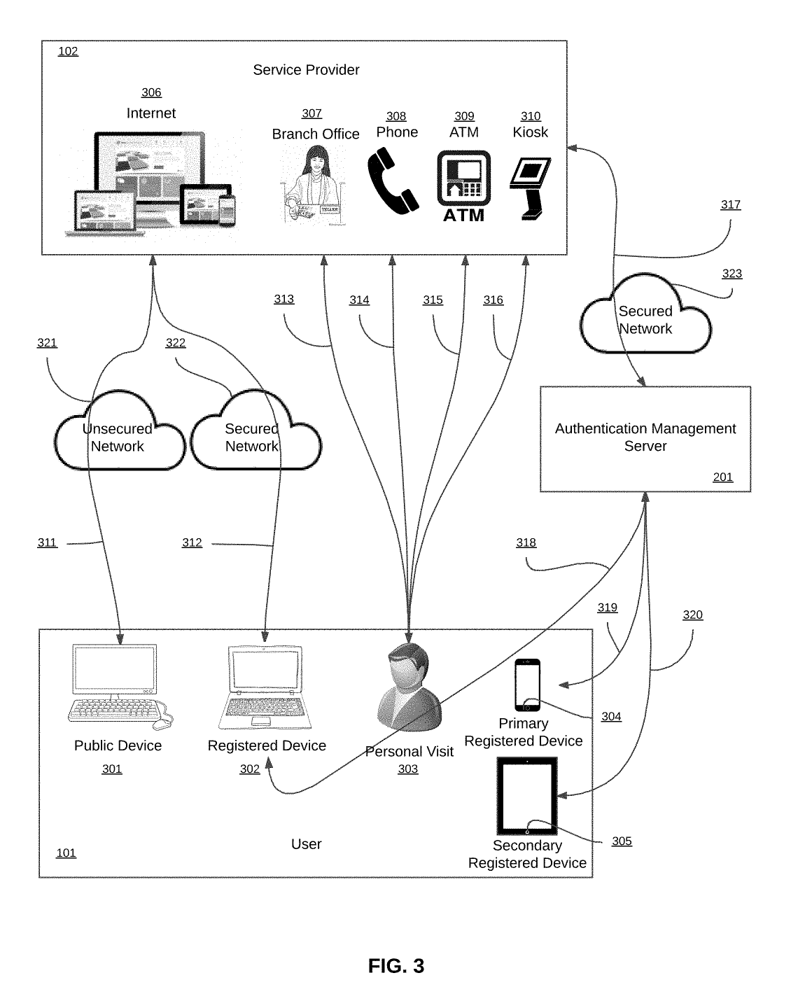

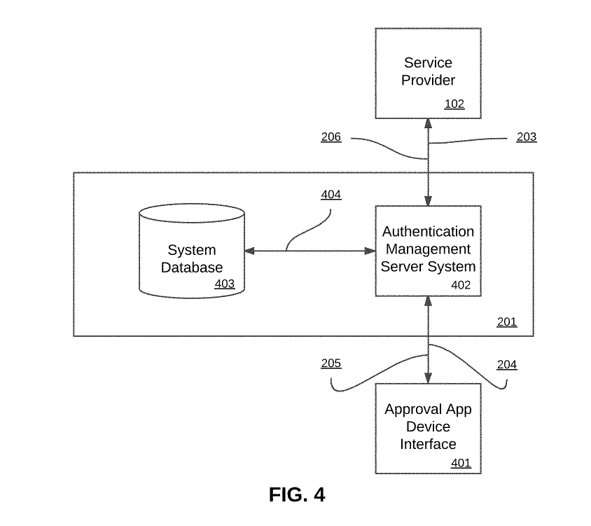

The service provider 102 then transmits a request for a password to the authentication management server 201 as illustrated in 203 in FIG. 2. The authentication management server 201 then communicates with the user 101 via push notification function of an approval app on his registered device (FIG. 18) by transmitting a request for approval (for a password) 204. The request from the service provider can be transmitted to all primary devices the user previously registered (e.g., a laptop he is currently using and a mobile phone in his pocket) 318, 319, 320 (FIG. 3). The user can review 1802 and approve the request from the service provider on either of his registered devices if it is legitimate and the user wishes to proceed (FIG. 20). When the user approves the request on his device 205, the authentication management server identifies the approval ID and the requesting service provider, fetches a matching password for the specific service provider 710 on its database 403, transmits 711, on its own secured network 323, a specific, preferably encrypted, password back to the service provider for authentication. A service provider may grant a user access 712 to its system on a device the user is using after its own successful verification.

This exemplary embodiment illustrates that only a user with the registered device receives a request for an approval and a true user of the device who can unlock the device can grant approval. Conversely, any person who is not in possession of the registered device or who does not possess a device unlocking authority even if the device is in his possession will not be able to grant (or refuse) approval. Furthermore, any unauthorized attempt to any service provider using the user's ID will be displayed on the user's device so the user can review, monitor, reject, and/or report any unauthorized attempts in real time.

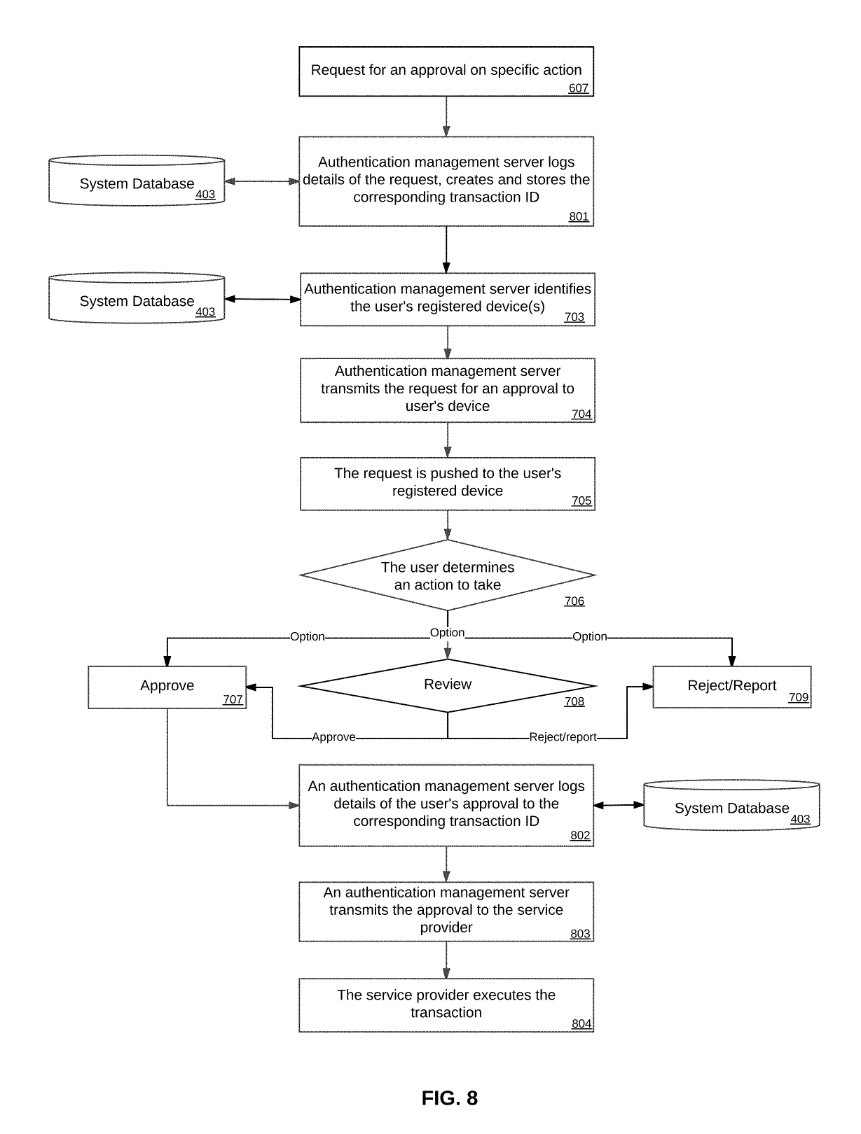

In some exemplary implementations, a service provider can transmit a request for an approval to take a specific action 607 as an alternative or addition to a separate authentication (FIG. 8). If the user is not already logged-in to a service provider, the request for an approval 607 can constitute both as a method for authenticating the user's identity and simultaneously obtaining the registered user's approval to take a specific action as an alternative or addition to traditional OTP (One Time Password) method. When the user is already logged-in to the service provider, the request for an approval to take a specific action 607 can be required by the service provider as another layer of security before executing sensitive tasks such as financial transactions as an alternative or addition to traditional OTP (One Time Password) method.

As an illustrative example of the above implementation, when a service provider (e.g., American Express credit card) determines that a user intends to complete a certain transaction such as authorizing a payment on another party's system (e.g., PayPal or a grocery store credit card terminal) without a separate authentication to its own system, the service provider can transmit a request for an approval to a user's device before executing the transaction via push notification function of an approval app on his registered device (FIG. 25). The request from the service provider can be transmitted to all primary devices the user previously registered (e.g., a mobile phone in his pocket). The user can review 2501 and approve 707 the request from the service provider on any of his registered devices if it is legitimate and the user wishes to proceed (FIG. 8). When the user approves the request on his device, the service provider can execute the transaction, and the authentication management server can generate and store on the user's database a unique transaction ID detailing the transaction 802. This implementation may complement or eliminate the OTP (One Time Password) method where a user receives a OTP from the service provider on his mobile phone or email, opens the message, transfers strings of characters to the device a user is using and finally executes the transaction.

In other exemplary implementation, a user can log-in to a service provider (e.g., Bank of America's internet banking site 306) and further intend to execute a specific action (e.g., wire transfer to a third party). The service provider can transmit a request for an approval 607 to a user's device before executing the transaction via push notification function of an approval app on his registered device (FIG. 25). The request from the service provider can be transmitted to all primary devices the user previously registered (e.g., a mobile phone in his pocket). The user can review 2501 and approve 707 the request from the service provider on any of his registered devices if it is legitimate and the user wishes to proceed (FIG. 8). When the user approves the request on his device, the service provider can execute the transaction, and the authentication management server can generate and store on the user's database a unique transaction ID detailing the transaction 802. This implementation may complement or eliminate the OTP (One Time Password) method where a user receives a OTP from the service provider on his mobile phone or email, opens the message, transfers strings of characters to the device a user is using and finally executes the transaction.

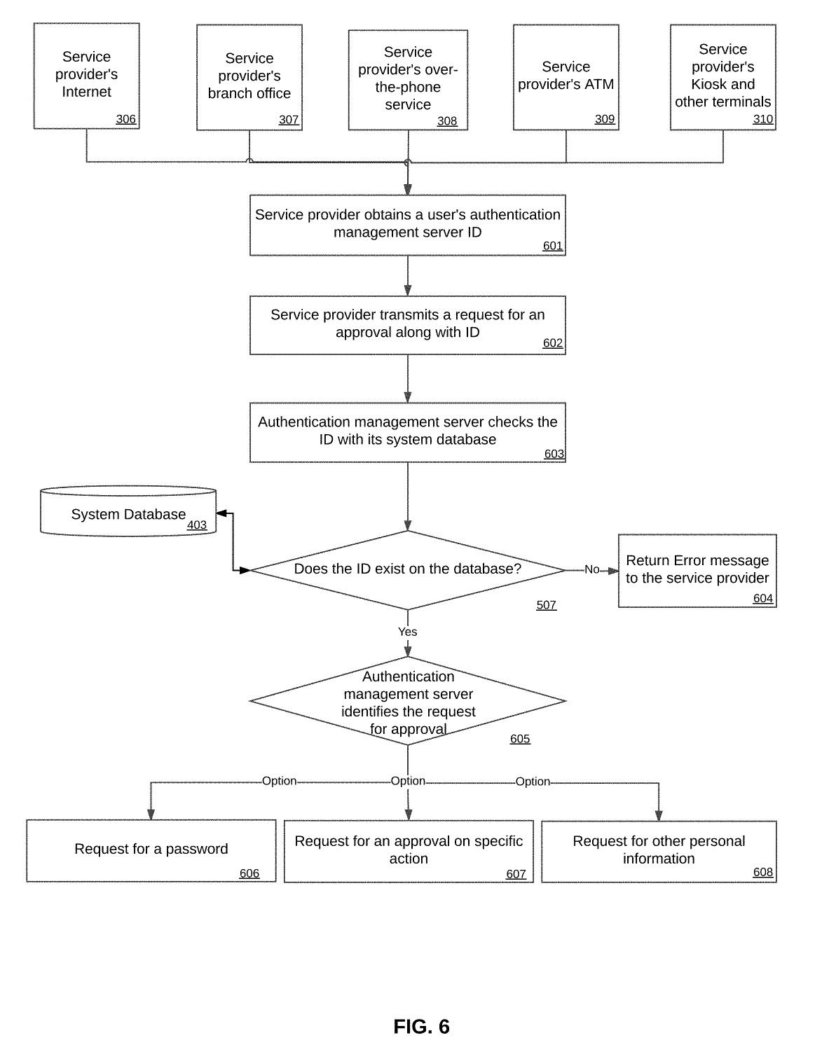

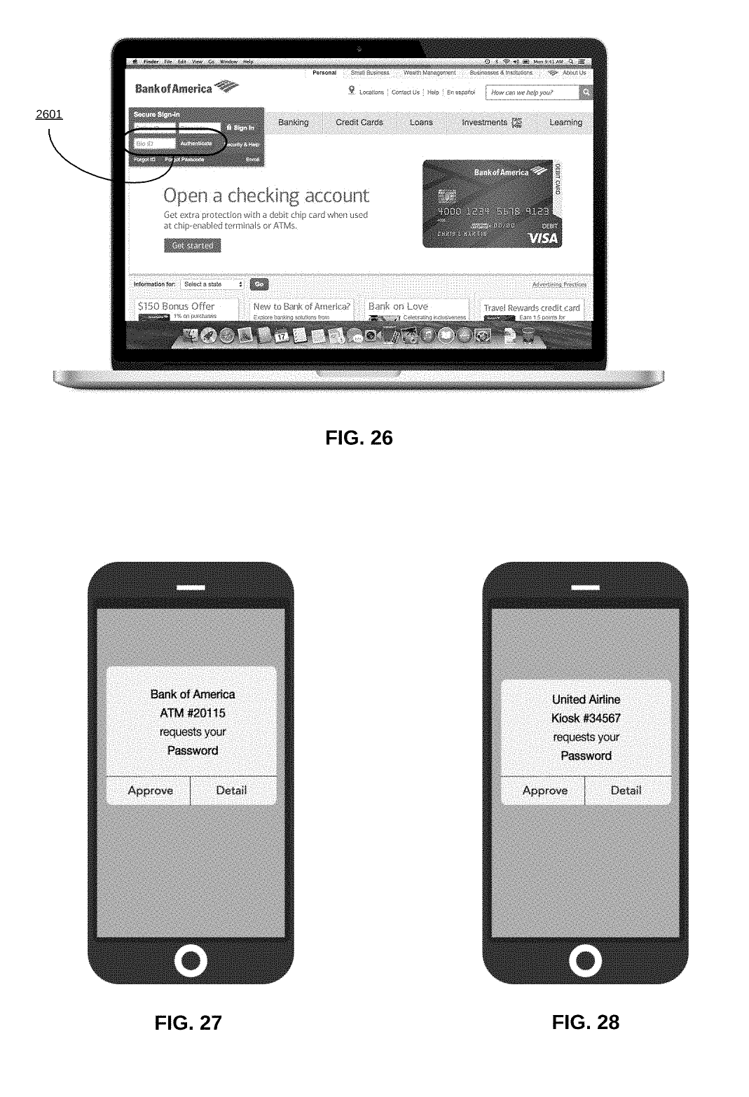

In some exemplary implementations, the following steps illustrate how a user with an existing approval ID can log in to a service provider which a user already has an existing account with using a non-registered device or a public device 301 (e.g., a computer at school, library, airport, or hotel) on a public or unsecured network 321. For example, a user can use a school computer's web browser to connect to a service provider's system (e.g., online banking). A user can simply enter his approval ID manually on the approval ID field 2601 of the service provider's sign in window and proceed (FIG. 26). Once a service provider obtains the user's approval ID 601, the process and the interaction methods between a service provider, an authentication management server through its accompanying approval app and the user at this moment may be identical as paragraph [74] and as illustrated in FIG. 6.

The request from the service provider can be transmitted to all primary devices the user previously registered. Therefore, as long as the user has at least one registered device with a cellular network or other interne connectivity with him (e.g., mobile phone), the user may be able to receive the request on his device and approve (or reject) the request. Since no password is entered or transmitted from a non-registered device 301, the non-registered device 301 (e.g., a school computer), cannot “remember” or store the password on its memory regardless of its current browser setting. Furthermore, no password is entered or transmitted using an unsecured (public) network 321, and the encrypted password is transmitted to a service provider, not from the unregistered device 301 on an unsecured public network 321 but, from the authentication management server 201 on its secure network. 323. Therefore, a risk of security breach is minimized even on a non-registered device on an unsecured public network.

In some exemplary implementations, the following steps illustrate how a user with an existing approval ID can log in to a service provider which a user already has an existing account with using a public device provided by a service provider such as ATM 309, terminal or airline Kiosk 310. A user may simply enter his ID manually on the device provided by the service provider or present, insert, swipe, tap or otherwise make available a debit, credit or ID card or other identifying apparatus which contains a user's unique ID to the service provider for it to retrieve the user's matching approval ID. Once a service provider obtains the user's approval ID through its public device (e.g., ATM 309, terminal or airline Kiosk 310), the process and the interaction methods between a service provider, an authentication management server through its accompanying approval app and the user at this moment may be identical as paragraph [74] and as also illustrated in FIGS. 27 and 28.

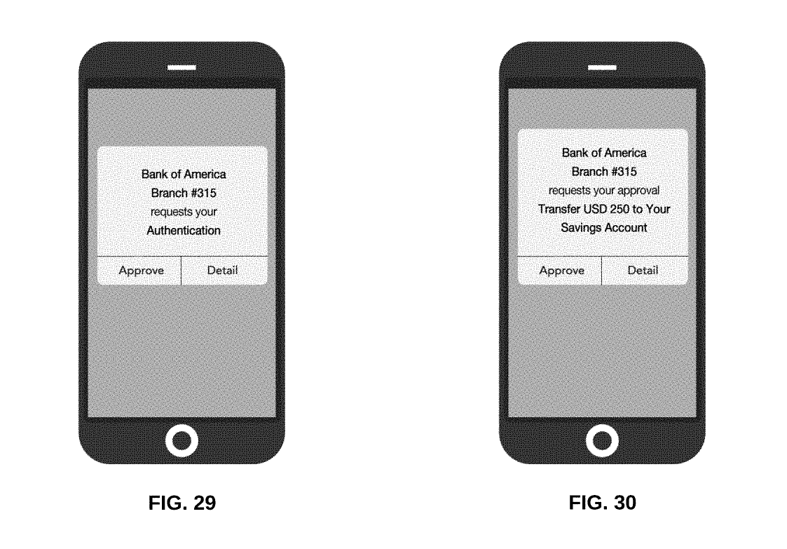

In other exemplary implementations, a user may visit a service provider's place of business such as a branch office 307 or local store. An exemplary authentication process in this kind of situation may comprise the following steps. A user may approach a representative of the service provider over the counter and present, insert, swipe, tap or otherwise make available a debit, credit or ID card or other identifying apparatus which contains a user's unique ID to the service provider for it to retrieve a user's matching approval ID. Once a service provider obtains the user's ID associated with the authentication management server, the process and the interaction methods between a service provider, an authentication management server through its accompanying approval app and a user at this moment may be identical as paragraph [74] and as also illustrated in FIGS. 29 and 30.

In some exemplary implementations, the following steps illustrate how a user may set up a new device in case the reistered primary device is lost, stolen or otherwise compromised using a similar device to device authentication method described in FIG. 10. The user of the lost registered primary device can follow the steps illustrated in FIG. 5 to download, install, and run the approval app on a new device (e.g., a new smart phone) which the user intends to register. On the approval app's user interface on the new device, the user can click on “Already have an account” option 1102 and enter his existing approval ID. The approval app, after communicating with the authentication management server, can confirm the existing ID and further display that the current device is not registered as the “trusted device” and provide the user with possible three options to proceed. (FIG. 10) Option 1: Register this device using one of the primary devices 1001. Option 2: Register this device using other registered devices 1002. Option 3: Register this device using the password 1003.

The user in this example may not wish to use Option 1. 1001 since the primary device is either lost, stolen, or compromised. Therefore, the user cannot grant approval when the request is pushed by the authentication management server through the approval app. When the user clicks on Option 2 1102, the authentication management server communicates with the user by transmitting a request (to register a new device) for approval via push notification function of the approval app on the other registered device(s) 1008 instead of his primary device FIG. 15. The user can review and approve the request from the authentication management server on his other registered devices 305 (e.g., an iPad or tablet PC) if it is legitimate and the user wishes to proceed 707. Alternatively, the user may ask the entrusted user who was added as an additional device in paragraph [64] and [65] so he can approve the request on his device when the request from the authentication management server is pushed on his device. The authentication management server then registers the new device under the user's approval ID 1011. Once the new device is successfully registered, the user may access the setting of the approval app on the new device to remove lost, stolen or otherwise compromised device and/or to list the new device as a primary device. Any person who is not in possession of the registered device or who cannot unlock the device even if the device is in his possession cannot grant (or refuse) approval.

If an unauthorized person attempts to use the approval ID of another user without the registered device, the attempt will fail because he does not have the registered device to approve the request sent by the authentication management server. Moreover, the true user with the registered primary device will be notified in real time since the push notification will seek his approval on the device where a user can easily refuse or report unusual activity. If an unauthorized person attempts to use the approval ID of another user with a stolen registered device, the attempt will fail because he does not have the requisite biometric data to unlock the registered device, which has been previously set up by the true user.

The term “authentication” as used herein is intended to include passwords, passcodes, or other authentication credentials. A user may be required to submit or, more generally, any other action that a user may be required to perform in order to gain access to an access-controlled system or to authorize a specific transaction to take a place.

It should be again emphasized that all embodiments which have been described herein are provided by way of illustration only and should not be construed as limiting. All embodiments herein may be combined in all possible combinations with each other. Although examples are described in detail herein with reference to the accompanying drawings, it is to be understood that the examples are not limited to those precise descriptions and illustrations. As such, many modifications and variations will be apparent to those of ordinary skill in the art. Accordingly, it is contemplated that a particular feature described either individually or in part of an example can be combined with other individually described features, or parts of other examples, even if the other features and examples make no mentioned of the particular feature.

1. A method for authentication of a user to a service provider, the method being performed by an authentication management server system, using one or more processors and comprising the following:
receiving a request for a user's password from a service provider;
transmitting the request to one or more registered devices of the user; and
transmitting the user's corresponding password to the service provider upon the user's approval.

2. The method of claim 1, wherein the methods for a service provider to obtain the user's ID for transmittal to the authentication management server includes the user's manual or automatic entry of the ID on a device through an internet based service such as a website, remote network, a separate software application installed on a user's device, intranet based connection, or a specialized remote terminal.

3. The method of claim 1, wherein the methods for a service provider to obtain the user's ID for transmittal to the authentication management server further includes a user physically visiting its place of business, or dialing-in to an automated system or to a live customer service staff of a service provider and presenting the user ID for transmittal to the authentication management server.

4. The method of claim 1, wherein the user is required to enable the lock/unlock feature of the device by using the device's own biometric authentication process, password or pattern input, or any other means the user is able to set within the device.

5. The method of claim 1, wherein the request for an approval is pushed to the user's device display.

6. The method of claim 1, wherein the request for an approval expires within a certain limited time.

7. The method of claim 1, wherein unlocking the device is a prerequisite to reviewing and accessing the request for an approval.

8. The method of claim 1, wherein the same action by the user to unlock the device is required to approve a request whether the device is already unlocked or not.

9. The method of claim 1, wherein the request for approval contains an option module wherein the user is given multiple options including, “approve”, “reject/report”, or “more detail” to select from.

10. The method of claim 6, wherein one or more options in the option module allows the user to review and manage the request in detail.

11. The method of claim 1, wherein the authentication management server further performs the steps of:
confirming the ID provided by a service provider with its database to find the corresponding user of the ID and one or more registered devices of the user for transmittal;
verifying whether the database of the user contains a password for the requesting service provider;
retrieving a corresponding password for the requesting service provider from its database if the verification is successful; and
transmitting a request for an approval to one or more registered devices of the user.

12. The method of claim 8, wherein the authentication management server further performs the steps of:
notifying the user if the user's database does not contain a password specific to the requesting service provider;
providing the user with one or more methods for creating a new password for the requesting service provider on the device display; and
storing a new password on its database for the user for transmittal to the service provider upon creation of a password by the user.

13. The method of claim 9, wherein the methods for creating a password includes password random generation by the authentication management server or manual entry by the user.

14. The method of claim 1, wherein the user further preforms the steps of:
unlocking the device;
reviewing the request for a password on his device's display;
verifying whether the request is legitimate or not; and
taking any predetermined action on any of the registered devices to effectuate the approval.

15. A method of authentication of a user for authorizing a specific action a service provider may take, the method being performed by an authentication management server system, using one or more processors and comprising:
receiving a request for an approval to take a specific action from a service provider;
transmitting the request for an approval to one or more registered devices of the user; and
transmitting the user's approval to the service provider upon the user's approval for completion of the requested action.

16-30. (canceled)

31. A method of claim for providing a service provider with the user's personal information, the method being performed by an authentication management server system, using one or more processors and comprising;
receiving a request for the information from a service provider;
transmitting a request for an approval to one or more registered devices of the user; and
transmitting the user's corresponding approval(s) to the service provider upon the user's approval.

32-53. (canceled)
